(19) United States
(12) Patent Application Publication
(10) Pub. No.: US 2026/0134678 A1
(43) Pub. Date: May 14, 2026

(54) PRIVACY-PRESERVING MACHINE LEARNING PROCESSING THAT IS RESPONSIVE TO FLUCTUATING BANDWIDTH AVAILABILITY

(71) Applicant: WING AVIATION LLC, Palo Alto, CA (US)

(72) Inventors: Marcus Hammond, Palo Alto, CA (US); Ali Shoeb, San Rafael, CA (US); Brandon Jones, Redwood City, CA (US)

(21) Appl. No.: 18/943,611

(22) Filed: Nov. 11, 2024

(51) Int. Cl. G06V 10/94; G06V 10/82; G06V 20/56

(52) U.S. Cl. CPC G06V 10/95; G06V 10/82; G06V 20/56

(57) ABSTRACT

In some embodiments, a computer-implemented method of communicating sensor data between an autonomous vehicle computing system and a remote computing system is provided. The autonomous vehicle computing system gathers sensor data generated by at least one sensor of the autonomous vehicle computing system. The autonomous vehicle computing system determines an amount of available bandwidth between the autonomous vehicle computing system and the remote computing system. The autonomous vehicle computing system retrieves a local portion of a split machine learning model corresponding to the amount of available bandwidth from a model data store. The autonomous vehicle computing system processes the sensor data using the local portion to produce an intermediate result. The autonomous vehicle computing system transmits the intermediate result to the remote computing system for processing of the intermediate result using a remote portion of the split machine learning model.

### TECHNICAL FIELD

This disclosure relates generally to network communication, and in particular but not exclusively, relates to network communication between autonomous vehicles and remote computing systems.

### BACKGROUND

Autonomous vehicles, including but not limited to unmanned aerial vehicles (UAVs), are used in an increasing variety of applications. For example, UAVs are used for capturing aerial imagery, package delivery, and a variety of other uses. In order to support autonomous operation, UAVs often use machine learning techniques to process sensor data. For example, UAVs often use machine learning techniques to process imagery collected by cameras mounted on the UAVs to identify objects present in the imagery, semantically determine a position of the UAVs (either in relation to visible objects or an absolute position), or for other purposes; to predict future states of the UAVs (e.g., to predict failures, to predict state-of-charge of a battery, etc.).

Though machine learning techniques can be highly useful, it is often desirable to share processing of sensor data between a UAV and a server or other remote computing system. While distributing computing to edge devices such as UAVs may help increase the scale of computation, there may still be situations in which leveraging server-scale compute resources is desirable. Further, even if edge devices such as UAVs are able to perform a majority of machine learning processing, the results of such processing are often desired at a server during operation of the UAVs, or would be desirable to be shared between UAVs.

There are at least two significant technical issues with communicating machine learning information between UAVs and remote computing systems while the UAVs are operating. A first technical issue is that the wireless bandwidth available to the UAV fluctuates during operation. As the UAV travels along a route, longer range but lower bandwidth connections (e.g., LTE, 3G) may be available when compared to connections that are available when the UAV is within a usable distance of a shorter range but higher bandwidth communication medium (e.g., Wi-Fi). Accordingly, it may not be always be feasible to transmit the same amount of information from the UAVs while maintaining the low amounts of communication latency used during autonomous operations.

A second technical issue arises with regard to the privacy of sensor data. The sensors of UAVs have the ability to capture sensitive data, such as images of people, textual information (e.g., license plates of cars, etc.), objects in private areas of residential properties, and so on. While it may be difficult to prevent sensors of a UAV from being exposed to sensitive data, it is desirable to protect sensitive data from disclosure during transmission from the UAV, and/or to prevent the sensitive data from being recovered by the remote computing systems at all, while still providing enough information to the remote computing system to be used for machine learning processing.

### BRIEF SUMMARY

In some embodiments, a computer-implemented method of communicating sensor data between an autonomous vehicle computing system and a remote computing system is provided. The autonomous vehicle computing system gathers sensor data generated by at least one sensor of the autonomous vehicle computing system. The autonomous vehicle computing system determines an amount of available bandwidth between the autonomous vehicle computing system and the remote computing system. The autonomous vehicle computing system retrieves a local portion of a split machine learning model corresponding to the amount of available bandwidth from a model data store. The autonomous vehicle computing system processes the sensor data using the local portion to produce an intermediate result. The autonomous vehicle computing system transmits the intermediate result to the remote computing system for processing of the intermediate result using a remote portion of the split machine learning model.

In some embodiments, a non-transitory computer-readable medium having computer-executable instructions stored thereon is provided. The instructions, in response to execution by one or more processors of an autonomous vehicle computing system, cause the autonomous vehicle computing system to perform actions for communicating sensor data between the autonomous vehicle computing system and a remote computing system, the actions comprising: gathering, by the autonomous vehicle computing system, sensor data generated by at least one sensor of the autonomous vehicle computing system; determining, by the autonomous vehicle computing system, an amount of available bandwidth between the autonomous vehicle computing system and the remote computing system; retrieving, by the autonomous vehicle computing system, a local portion of a split machine learning model corresponding to the amount of available bandwidth from a model data store; processing, by the autonomous vehicle computing system, the sensor data using the local portion to produce an intermediate result; and transmitting, by the autonomous vehicle computing system, the intermediate result to the remote computing system for processing of the intermediate result using a remote portion of the split machine learning model.

### BRIEF DESCRIPTION OF THE SEVERAL VIEWS OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described. To easily identify the discussion of any particular element or act, the most significant digit or digits in a reference number refer to the figure number in which that element is first introduced.

FIG. 1 is a schematic illustration of a system in which an autonomous vehicle communicates with a remote computing system, according to various aspects of the present disclosure.

FIG. 2 is a block diagram that illustrates a non-limiting example embodiment of an autonomous vehicle computing system according to various aspects of the present disclosure.

FIG. 3A and FIG. 3B illustrate an aerial vehicle or UAV 300, in accordance with an embodiment of the present disclosure

FIG. 4 is a block diagram that illustrates aspects of a non-limiting example embodiment of a remote computing system according to various aspects of the present disclosure.

FIG. 5A - FIG. 5B are a flowchart that illustrates a non-limiting example embodiment of a method of processing sensor data between an autonomous vehicle computing system and a remote computing system, according to various aspects of the present disclosure.

FIG. 6A - FIG. 6D are schematic illustrations of non-limiting example embodiments of artificial neural network architectures for use in creating a split machine learning model, according to various aspects of the present disclosure.

FIG. 7A and FIG. 7B are schematic illustrations of non-limiting example embodiments of encoder-decoder architectures for use in creating a split machine learning model, according to various aspects of the present disclosure.

### DETAILED DESCRIPTION

In some embodiments of the present disclosure, a split machine learning model is used to split machine learning processing between an autonomous vehicle and a remote computing system. A local portion of the split machine learning model is used by the autonomous vehicle to create an intermediate result, and the intermediate result is transmitted to the remote computing system. The remote computing system processes the intermediate result result with a remote portion of the split machine learning model to create a complete result, which may then be used for any purpose for which the output of a single machine learning model could be used.

The use of a split machine learning model provides multiple technical benefits. For example, the benefit of being able to distribute computation between multiple devices (i.e., the autonomous vehicle and the remote computing system) increases the amount of available computing power, and therefore increases the speed at which results may be generated. As another example, multiple split machine learning models may be deployed that create intermediate results of different sizes. By selecting an appropriate split machine learning model at an appropriate time, an intermediate result of a size appropriate for the current amount of available bandwidth for communication between the autonomous vehicle and the remote computing system may be generated. As yet another example, the privacy of sensitive information within the sensor data can be preserved. The transmission of an intermediate result by a split machine learning model instead of the sensor data itself already obfuscates the data while in transit, and by properly training the split machine learning model to generate intermediate results that cannot be used to reliably reproduce the sensitive information (but while still generating the desired output), the sensitive information can be protected even from the remote computing system.

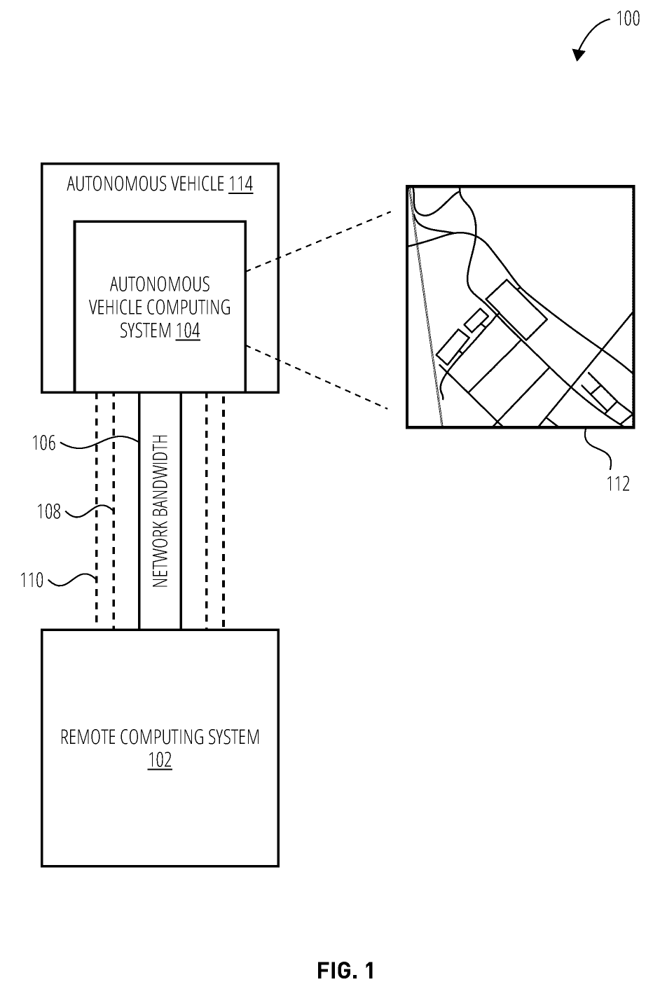

FIG. 1 is a schematic illustration of a system in which an autonomous vehicle communicates with a remote computing system, according to various aspects of the present disclosure. As shown, the system 100 includes an autonomous vehicle 114 and a remote computing system 102. The autonomous vehicle 114 includes an autonomous vehicle computing system 104 having sensor devices that collect information relevant to the operation of the autonomous vehicle 114, including but not limited to information regarding an operational area 112 (e.g., two-dimensional imagery, three-dimensional imagery, etc.).

The autonomous vehicle 114 may be any type of autonomous vehicle, including but not limited to an unmanned aerial vehicle (UAV), an autonomous passenger car or truck, or any other type of vehicle that collects sensor data and transmits it to a remote computing system 102. Though a single autonomous vehicle 114 is illustrated for the sake of clarity, one will recognize that in some embodiments, a plurality of autonomous vehicles 114 may be present in the system 100 and communicating with the remote computing system 102.

The autonomous vehicle computing system 104 is configured to transmit gathered sensor data to the remote computing system 102. Typically, the autonomous vehicle computing system 104 transmits the sensor data to the remote computing system 102 during operation, and may do so over one or more wireless networks. Depending on various conditions (e.g., a distance between the autonomous vehicle 114 and a network access point, an amount of concurrent network traffic from other devices, etc.), the amount of available bandwidth for communication between the autonomous vehicle 114 and the remote computing system 102 may change. The illustrated first network bandwidth 106 schematically illustrates a minimal amount of available bandwidth, while the second network bandwidth 108 and third network bandwidth 110 schematically illustrate greater amounts of available bandwidth that may be available at different times.

While it may be desired to transmit all available sensor data from the autonomous vehicle 114 to the remote computing system 102, the varying amount of available bandwidth may not make this practical. Communication delay may be significant if the amount of available bandwidth is the first network bandwidth 106 as opposed to the second network bandwidth 108 or the third network bandwidth 110. In embodiments wherein processing of sensor data by the remote computing system 102 helps support the real-time operation of the autonomous vehicle 114, increased communication delay can lead to delay in the generation and transmission of operational commands, thereby causing significant problems with the operation of the autonomous vehicle 114. It should also be noted that if the sensor data includes sensitive information, it may not be desirable to transmit the sensor data wirelessly, and in some circumstances, in may not be desirable for the remote computing system 102 to have possession of the sensitive information at all. What is desired is a system wherein an appropriate amount of information is transmitted between the autonomous vehicle computing system 104 and the remote computing system 102 for the currently amount of available bandwidth, while also protecting the privacy of the transmitted information.

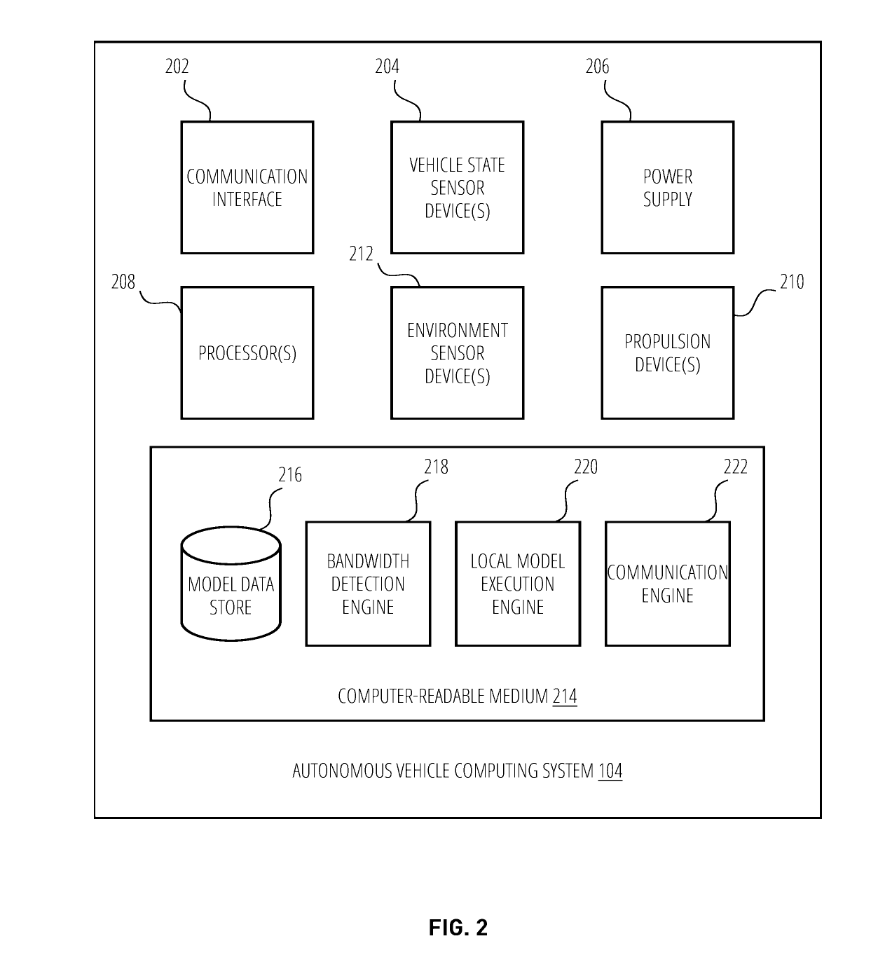

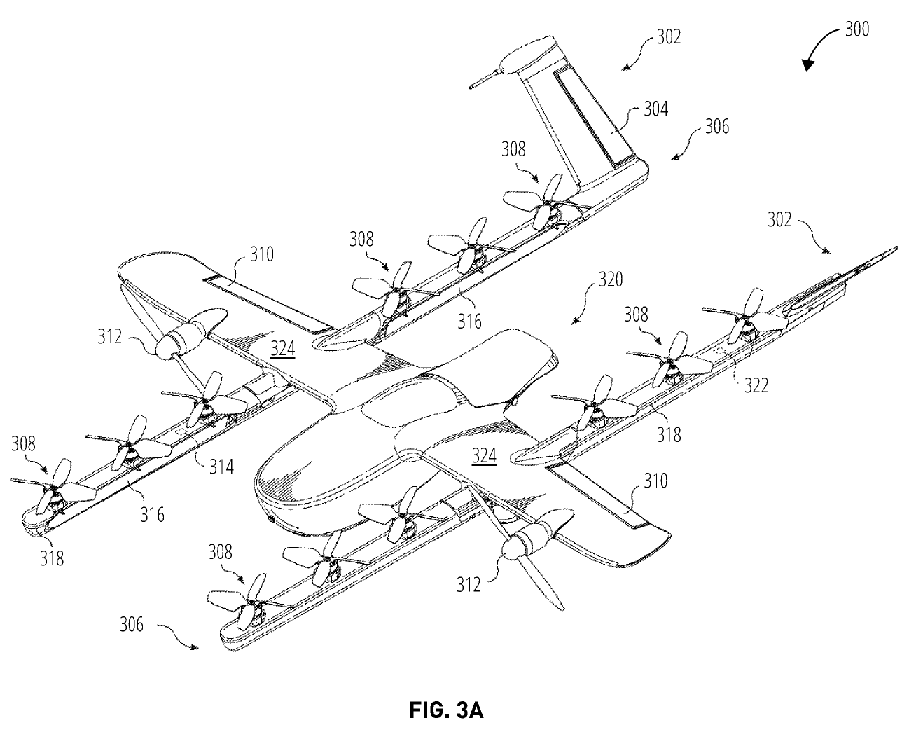

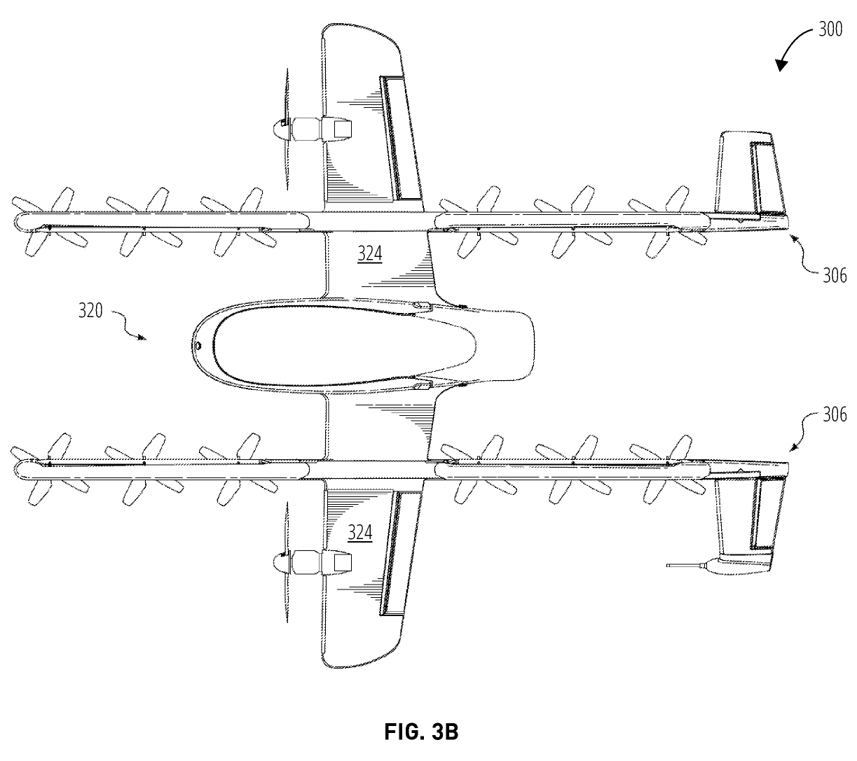

FIG. 2 is a block diagram that illustrates a non-limiting example embodiment of an autonomous vehicle computing system according to various aspects of the present disclosure. The autonomous vehicle computing system 104 is configured to operate an autonomous vehicle 114, and includes several components that might be considered part of the autonomous vehicle 114 (e.g., the propulsion devices 210, the power supply 206, etc., as described in further detail below). In some embodiments, the autonomous vehicle computing system 104 is an aircraft such as the UAV 300 illustrated in FIG. 3A and FIG. 3B. In some embodiments, the autonomous vehicle computing system 104 may be incorporated into another type of autonomous vehicle, including but not limited to an autonomous passenger automobile or truck.

As shown, the autonomous vehicle computing system 104 includes a communication interface 202, one or more vehicle state sensor devices 204, a power supply 206, one or more processors 208, one or more environment sensor devices 212, one or more propulsion devices 210, and a computer-readable medium 214.

In some embodiments, the communication interface 202 includes hardware and software to enable any suitable communication technology for communicating with the remote computing system 102. In some embodiments, the communication interface 202 includes multiple communication interfaces, each for use in appropriate circumstances. For example, the communication interface 202 may include a long-range wireless interface such as a 4G or LTE interface, or any other type of long-range wireless interface (e.g., 2G, 3G, 5G, or WiMAX), to be used to communicate with remote computing system 102 while traversing a route. The communication interface 202 may also include a medium-range wireless interface such as a Wi-Fi interface to be used when the autonomous vehicle computing system 104 is at an area near a start location or an endpoint where Wi-Fi coverage is available. The communication interface 202 may also include a short-range wireless interface such as a Bluetooth interface to be used when the autonomous vehicle computing system 104 is in a maintenance location or is otherwise stationary and waiting to be assigned a route. The communication interface 202 may also include a wired interface, such as an Ethernet interface or a USB interface, which may also be used when the autonomous vehicle computing system 104 is in a maintenance location or is otherwise stationary and waiting to be assigned a route.

In some embodiments, the vehicle state sensor devices 204 are configured to detect states of various components of the autonomous vehicle 114, and to transmit signals representing those states to other components of the autonomous vehicle computing system 104. Some non-limiting examples of vehicle state sensor devices 204 include a battery state sensor and a propulsion device health sensor.

In some embodiments, the power supply 206 may be any suitable device or system for storing and/or generating power. Some non-limiting examples of a power supply 206 include one or more batteries, one or more solar panels, a fuel tank, and combinations thereof. In some embodiments, the propulsion devices 210 may include any suitable devices for causing the autonomous vehicle 114 to travel along a path. For an aircraft, the propulsion device 210 may include devices such as, but not limited to, one or more motors, one or more propellers, and one or more flight control surfaces.

In some embodiments, the one or more environment sensor devices 212 may include any suitable type of camera for capturing imagery from the point of view of the autonomous vehicle 114. For example, the environment sensor devices 212 may include one or more of a downward-facing camera or an angled-view camera. In some embodiments, the one or more environment sensor devices 212 may include one or more cameras of any type, including but not limited to a visible light camera, an infrared camera, a light-field camera, a laser camera, a stereoscopic camera, or a time-of-flight camera. The environment sensor devices 212 may also include a GNSS sensor, one or more accelerometers (and/or other devices that are part of an inertial navigation system), LIDAR devices, and/or other sensor devices for sensing other aspects of an environment of the autonomous vehicle 114 or the relationship of the autonomous vehicle 114 to its environment.

In some embodiments, the processor 208 may include any type of computer processor capable of receiving signals from other components of the autonomous vehicle computing system 104 and executing instructions stored on the computer-readable medium 214. In some embodiments, the computer-readable medium 214 may include one or more devices capable of storing information for access by the processor 208. In some embodiments, the computer-readable medium 214 may include one or more of a hard drive, a flash drive, an EEPROM, and combinations thereof.

As shown, the computer-readable medium 214 has stored thereon a model data store 216, a bandwidth detection engine 218, a local model execution engine 220, and a communication engine 222. In some embodiments, the bandwidth detection engine 218 is configured to sense an amount of available bandwidth between the autonomous vehicle computing system 104 and the remote computing system 102. In some embodiments, the local model execution engine 220 is configured to use a local portion of a split machine learning model to process sensor data and create intermediate results. In some embodiments, the communication engine 222 is configured to receive the local portion from the remote computing system 102 and to store the local portion in the model data store 216, as well as to transmit the intermediate results to the remote computing system 102.

As used herein, "engine" refers to logic embodied in hardware or software instructions, which can be written in one or more programming languages, including but not limited to C, C++, C#, COBOL, JAVA™, PHP, Perl, HTML, CSS, JavaScript, VBScript, ASPX, Go, and Python. An engine may be compiled into executable programs or written in interpreted programming languages. Software engines may be callable from other engines or from themselves. Generally, the engines described herein refer to logical modules that can be merged with other engines, or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, "computer-readable medium" refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage.

As used herein, "data store" refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

FIG. 3A and FIG. 3B illustrate an aerial vehicle or UAV 300, in accordance with an embodiment of the present disclosure. The UAV 300 is a non-limiting example embodiment of an autonomous vehicle 114 within which an autonomous vehicle computing system 104 may be incorporated. It will be noted that some components of the autonomous vehicle computing system 104 (e.g., propulsion devices 210, power supply 206, various sensor devices, etc.) are illustrated in the UAV 300, while other components of the autonomous vehicle computing system 104 are not illustrated in FIG. 3A and FIG. 3B may nevertheless be present.

The illustrated embodiment of UAV 300 is a vertical takeoff and landing (VTOL) unmanned aerial vehicle (UAV) that includes separate propulsion units 312 and propulsion units 308 for providing horizontal and vertical propulsion, respectively. UAV 300 is a fixed-wing aerial vehicle, which as the name implies, has a wing assembly 324 that can generate lift based on the wing shape and the vehicle’s forward airspeed when propelled horizontally by propulsion units 312. FIG. 3A is a perspective top view illustration of UAV 300 while FIG. 3B is a bottom side plan view illustration of UAV 300.

The illustrated embodiment of UAV 300 includes a fuselage 320. In one embodiment, fuselage 320 is modular and includes a battery module, an avionics module, and a mission payload module. These modules are detachable from each other and mechanically securable to each other to contiguously form at least a portion of the fuselage 320 or UAV main body.

The battery module includes a cavity for housing one or more batteries for powering UAV 300. The avionics module houses flight control circuitry of UAV 300, which may include a processor and memory, communication electronics and antennas (e.g., cellular transceiver, Wi-Fi transceiver, etc.), and various sensors (e.g., global positioning sensor, an inertial measurement unit (IMU), a magnetic compass, etc.). The mission payload module houses equipment associated with a mission of UAV 300. For example, the mission payload module may include a payload actuator for holding and releasing an externally attached payload. In another embodiment, the mission payload module may include a camera/sensor equipment holder for carrying camera/sensor equipment (e.g., camera, lenses, radar, LIDAR, pollution monitoring sensors, weather monitoring sensors, etc.). Other components that may be carried by some embodiments of the UAV 300 are illustrated in FIG. 2.

The illustrated embodiment of UAV 300 further includes horizontal propulsion units 312 positioned on wing assembly 324, which can each include a motor, shaft, motor mount, and propeller, for propelling UAV 300. The illustrated embodiment of UAV 300 includes two boom assemblies 306 that secure to wing assembly 324.

The illustrated embodiments of boom assemblies 306 each include a boom housing 318 in which a boom is disposed, vertical propulsion units 308, printed circuit boards 316, and stabilizers 302. Vertical propulsion units 308 can each include a motor, shaft, motor mounts, and propeller, for providing vertical propulsion. Vertical propulsion units 308 may be used during a hover mode where UAV 300 is descending (e.g., to a delivery location) or ascending (e.g., following a delivery). Stabilizers 302 (or fins) may be included with UAV 300 to stabilize the UAV’s yaw (left or right turns) during flight. In some embodiments, UAV 300 may be configured to function as a glider. To do so, UAV 300 may power off its propulsion units and glide for a period of time.

During flight, UAV 300 may control the direction and/or speed of its movement by controlling its pitch, roll, yaw, and/or altitude. For example, the stabilizers 302 may include one or more rudders 304 for controlling the UAV’s yaw, and wing assembly 324 may include elevators for controlling the UAV’s pitch and/or ailerons 310 for controlling the UAV’s roll. As another example, increasing or decreasing the speed of all the propellers simultaneously can result in UAV 300 increasing or decreasing its altitude, respectively. The UAV 300 may also include components for sensing the environment around the UAV 300, including but not limited to audio sensor 322 and audio sensor 314. Further examples of sensor devices are illustrated in FIG. 2 and described below.

Many variations on the illustrated fixed-wing aerial vehicle are possible. For instance, aerial vehicles with more wings (e.g., an “x-wing” configuration with four wings), are also possible. Although FIG. 3A and FIG. 3B illustrate one wing assembly 324, two boom assemblies 306, two horizontal propulsion units 312, and six vertical propulsion units 308 per boom assembly 306, it should be appreciated that other variants of UAV 300 may be implemented with more or fewer of these components.

It should be understood that references herein to an “unmanned” aerial vehicle or UAV can apply equally to autonomous and semi-autonomous aerial vehicles. In a fully autonomous implementation, all functionality of the aerial vehicle is automated; e.g., pre-programmed or controlled via real-time computer functionality that responds to input from various sensors and/or pre-determined information. In a semi-autonomous implementation, some functions of an aerial vehicle may be controlled by a human operator, while other functions are carried out autonomously. Further, in some embodiments, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator may control high level navigation decisions for a UAV, such as specifying that the UAV should travel from one location to another (e.g., from a warehouse in a suburban area to a delivery address in a nearby city), while the UAV’s navigation system autonomously controls more fine-grained navigation decisions, such as the specific route to take between the two locations, specific flight controls to achieve the route and avoid obstacles while navigating the route, and so on.

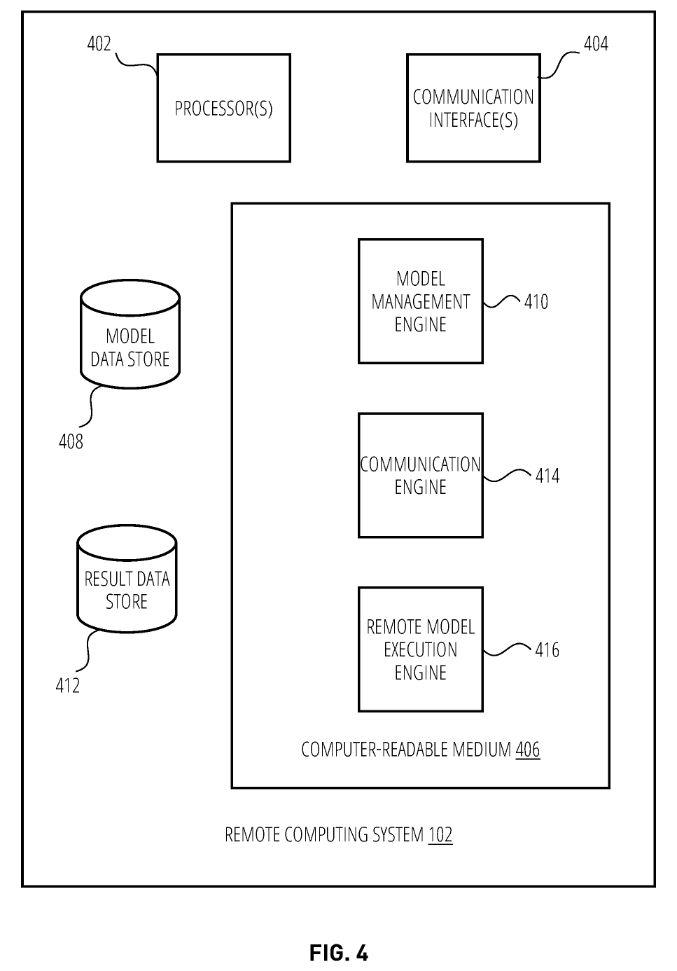

FIG. 4 is a block diagram that illustrates aspects of a non-limiting example embodiment of a remote computing system according to various aspects of the present disclosure. The illustrated remote computing system 102 may be implemented by any computing device or collection of computing devices, including but not limited to a desktop computing device, a laptop computing device, a mobile computing device, a server computing device, a computing device of a cloud computing system, and/or combinations thereof. The remote computing system 102 is configured to train split machine learning models, to distribute local portions of the split machine learning models to autonomous vehicle computing systems 104, and to process intermediate results received from autonomous vehicle computing systems 104 using remote portions of the split machine learning models.

As shown, the remote computing system 102 includes one or more processors 402, one or more communication interfaces 404, a model data store 408, a result data store 412, and a computer-readable medium 406.

In some embodiments, the processors 402 may include any suitable type of general-purpose computer processor. In some embodiments, the processors 402 may include one or more special-purpose computer processors or AI accelerators optimized for specific computing tasks, including but not limited to graphical processing units (GPUs), vision processing units (VPUs), and tensor processing units (TPUs).

In some embodiments, the communication interfaces 404 include one or more hardware and or software interfaces suitable for providing communication links between components. The communication interfaces 404 may support one or more wired communication technologies (including but not limited to Ethernet, FireWire, and USB), one or more wireless communication technologies (including but not limited to Wi-Fi, WiMAX, Bluetooth, 2G, 3G, 4G, 5G, and LTE), and/or combinations thereof.

As shown, the computer-readable medium 406 has stored thereon logic that, in response to execution by the one or more processors 402, cause the remote computing system 102 to ample, provide a model management engine 410, a communication engine 414, and a remote model execution engine 416. In some embodiments, the model management engine 410 is configured to train split machine learning models, and to store the remote portions of the split machine learning models in the model data store 408. In some embodiments, the communication engine 414 is configured to transmit the local portions of the split machine learning models to the autonomous vehicle computing systems 104, and to receive intermediate results from the autonomous vehicle computing systems 104. In some embodiments, the remote model execution engine 416 is configured to use the remote portions to process the intermediate results and generate complete results, and to store the complete results in the result data store 412.

While the remote computing system 102 is illustrated and described as a stand-alone computing system, in some embodiments, the remote computing system 102 may be a computing system of a second autonomous vehicle 114 that is configured to receive intermediate results from a first autonomous vehicle 114 and execute a remote portion of a split machine learning model. In such embodiments, the remote computing system 102 may not include the model management engine 410 and may not train split machine learning models, but may instead merely store and execute pre-trained remote portions of split machine learning models. Such embodiments may be useful in many different situations, including but not limited to while multiple autonomous vehicles 114 are at a nest (i.e., a location for servicing multiple autonomous vehicles 114 by providing, for example, landing locations, power, maintenance, or other fleet management services). For example, a first autonomous vehicle 114 returning to the nest from a given operational area 112 may transmit intermediate results to other autonomous vehicles 114 at the nest for the purposes of pre-planning future flights to the given operational area 112.

Further description of the configuration of each of these components is provided below.

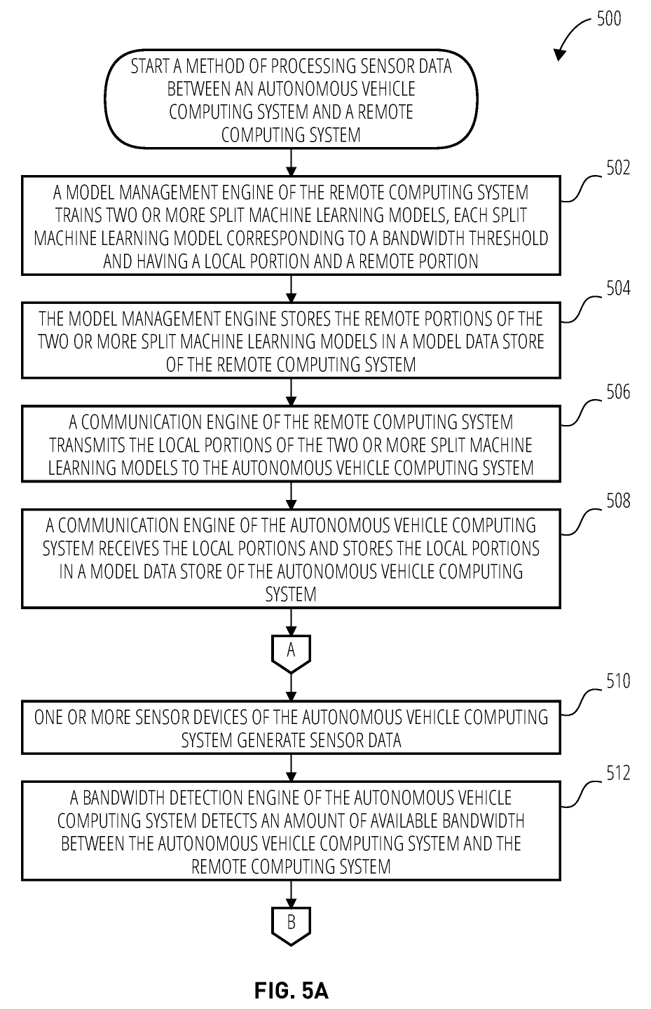

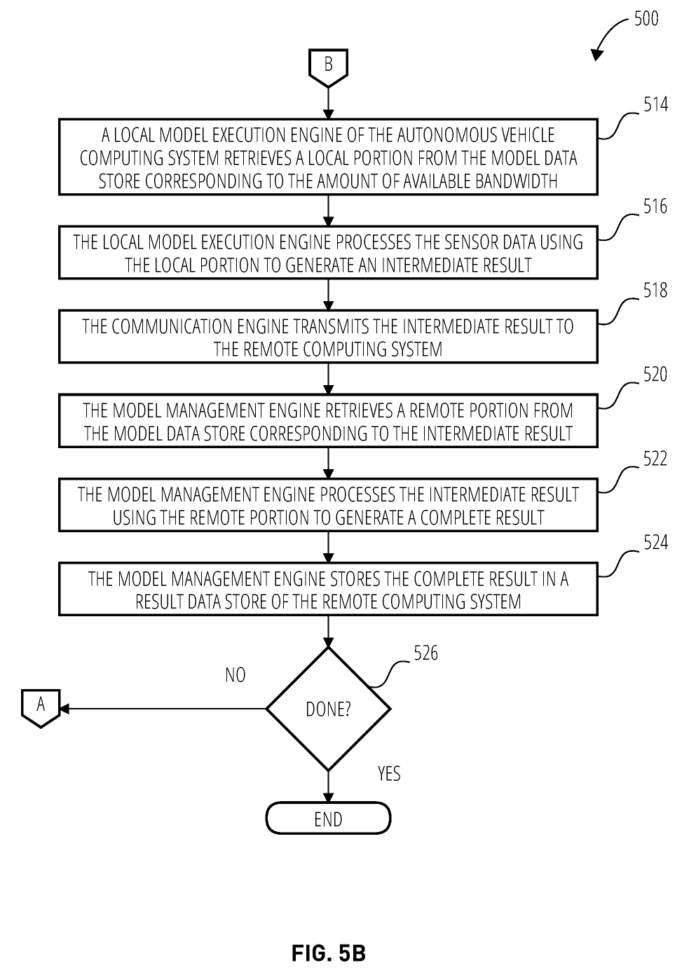

FIG. 5A - FIG. 5B are a flowchart that illustrates a non-limiting example embodiment of a method of processing sensor data between an autonomous vehicle computing system and a remote computing system, according to various aspects of the present disclosure. In the method 500, a split machine learning model is trained, with a local portion being stored by the autonomous vehicle computing system 104 and a remote portion being stored by the remote computing system 102. The autonomous vehicle computing system 104 collects sensor data, and uses the local portion to generate an intermediate result of an intermediate result type having a size appropriate for the amount of available bandwidth for transmission to the remote computing system 102. The remote computing system 102 receives the intermediate result and uses the remote portion to generate a complete result.

By executing the local portion at the autonomous vehicle computing system 104, computing resources are saved at the remote computing system 102, and by transmitting an intermediate result instead of the sensor data or the complete result, the privacy of the sensor data and the complete result are both maintained over the communication link. Further, by generating an intermediate result of an appropriate size for the amount of available bandwidth, communication latency during times of reduced bandwidth can be avoided, thus improving operation and control of the autonomous vehicle computing system 104.

From a start block, the method 500 proceeds to block 502, where a model management engine 410 of the remote computing system 102 trains two or more split machine learning models, each split machine learning model corresponding to a bandwidth threshold and having a local portion and a remote portion. Each split machine learning model may accept as input one or more types of sensor data, and may produce as output any desired type or types of output data. In some embodiments, the output may include one or more of semantic labels of objects visible in the sensor data, a recreation of the sensor data (or a portion thereof), an indication of a state of the autonomous vehicle 114, a predicted future state of the autonomous vehicle 114, or any other suitable type of output. Each split machine learning model may be trained using any suitable technique, including but not limited to gradient descent, an Adam optimizer, or any other suitable training technique.

The split machine learning models may use any machine learning model architecture that can produce an intermediate result which can be exchanged between a local portion of the split machine learning model and a remote portion of the split machine learning model. As one non-limiting example embodiment of a suitable machine learning model architecture, the machine learning model architecture may be an artificial neural network, with the local portion including the input layer and zero or more hidden layers, the remote portion including zero or more hidden layers and the output layer, and the intermediate result being a set of activations between the local portion and the remote portion. By changing the size of the layer that generates the set of activations (and thereby changing the size of the set of activations), the size of the intermediate result can be adjusted to be appropriate for different amounts of available bandwidth.

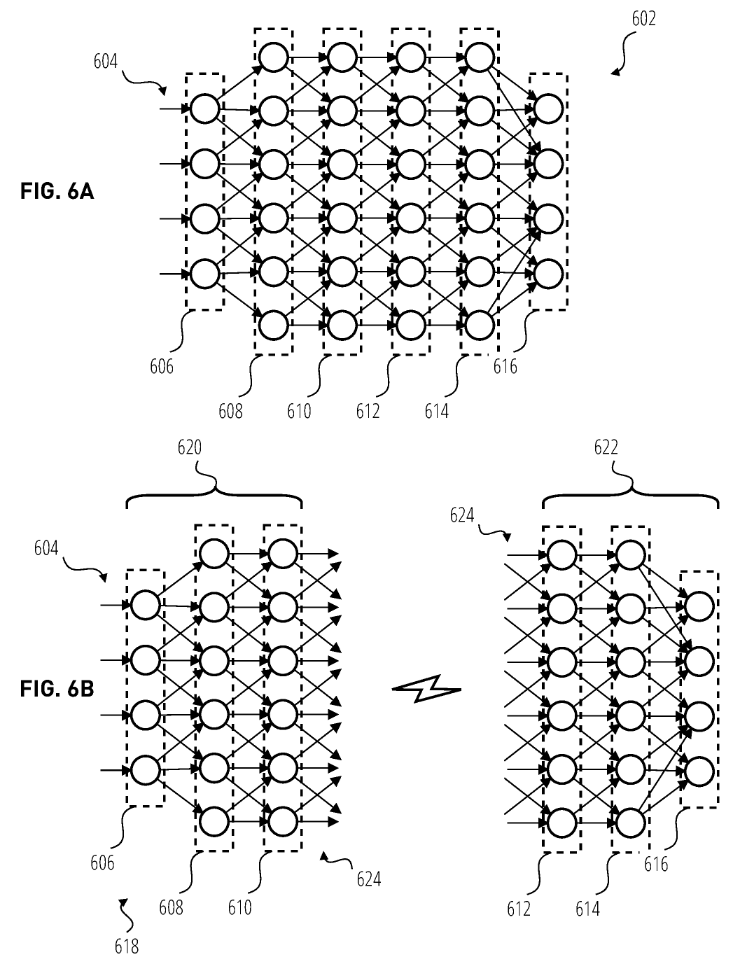

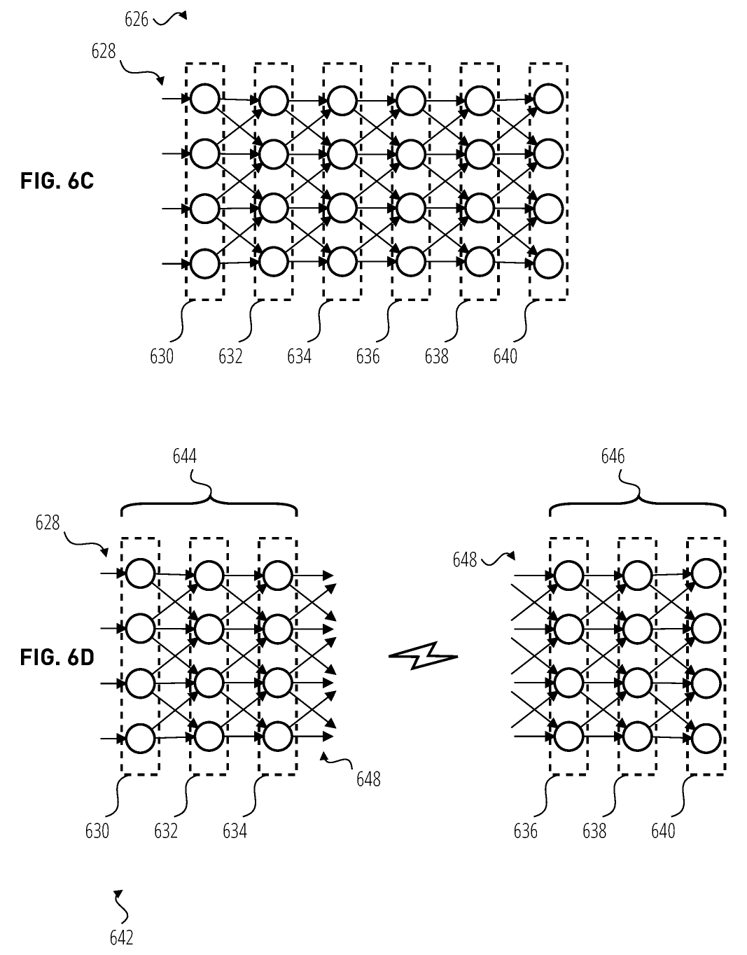

FIG. 6A - FIG. 6D are schematic illustrations of non-limiting example embodiments of artificial neural network architectures for use in creating a split machine learning model, according to various aspects of the present disclosure. FIG. 6A shows a simplified representation of a first machine learning model architecture 602. The first machine learning model architecture 602 includes input values 604 (i.e., sensor data or features derived therefrom) provided to an input layer 606 with four input nodes; a first hidden layer 608, a second hidden layer 610, a third hidden layer 612, and a fourth hidden layer 614 with six hidden nodes each; and an output layer 616 with four output nodes. Arrows connecting nodes in the drawing indicate activations transmitted from one node to another. As illustrated, the first machine learning model architecture 602 is a feedforward design, though one will recognize that in other embodiments, other designs could be used for connections between two or more of the layers.

Once a machine learning model using the first machine learning model architecture 602 is trained, it may be broken apart according to the first split machine learning model architecture 618 illustrated in FIG. 6B. As shown, the input layer 606, first hidden layer 608, and second hidden layer 610 have been split into a local portion 620, and the third hidden layer 612, fourth hidden layer 614, and output layer 616 have been split into a remote portion 622. The activations generated by the second hidden layer 610 become the first intermediate result 624, and the first intermediate result 624 is transmitted from the autonomous vehicle computing system 104 to the remote computing system 102. This allows the same output values to be generated by the output layer 616 without transmitting the input values 604 between the autonomous vehicle computing system 104 and the remote computing system 102, thus protecting the privacy of the data represented by the input value 604.

FIG. 6C illustrates a simplified representation of a second machine learning model architecture 626. The second machine learning model architecture 626 is similar to the first machine learning model architecture 602, in that it also includes four input values 628 and an input layer 630 with four input nodes, a first hidden layer 632, a second hidden layer 634, a third hidden layer 636, a fourth hidden layer 638, and an output layer 640. However, the hidden layers of the second machine learning model architecture 626 have four nodes each, as opposed to the six nodes each of the hidden layers of the first machine learning model architecture 602. Corresponding to this, while the hidden layers of the first machine learning model architecture 602 were each connected with sixteen activations, the hidden layers of the second machine learning model architecture 626 are each connected with ten activations.

FIG. 6D illustrates a second split machine learning model architecture 642 based on the second machine learning model architecture 626. The input layer 630, first hidden layer 632, and second hidden layer 634 are split into a local portion 644, and the third hidden layer 636, fourth hidden layer 638, and output layer 640 are split into a remote portion 646. Since there are fewer activations connecting the hidden layers, the second intermediate result 648 (i.e., the activations generated by the second hidden layer 634) generated by the local portion 644 of the second split machine learning model architecture 642 is of a second intermediate result type has a smaller size than the first intermediate result 624 of the first intermediate result type generated by the local portion 620 of the first split machine learning model architecture 618.

Reducing the size of the hidden layers is a non-limiting example of how the size of the intermediate result for a split machine learning model that uses a neural network architecture may be reduced. In other embodiments, other techniques may be used, including but not limited to keeping the size of the hidden layers the same but reducing the number of connections between hidden layers (i.e., the number of activations generated by each hidden node).

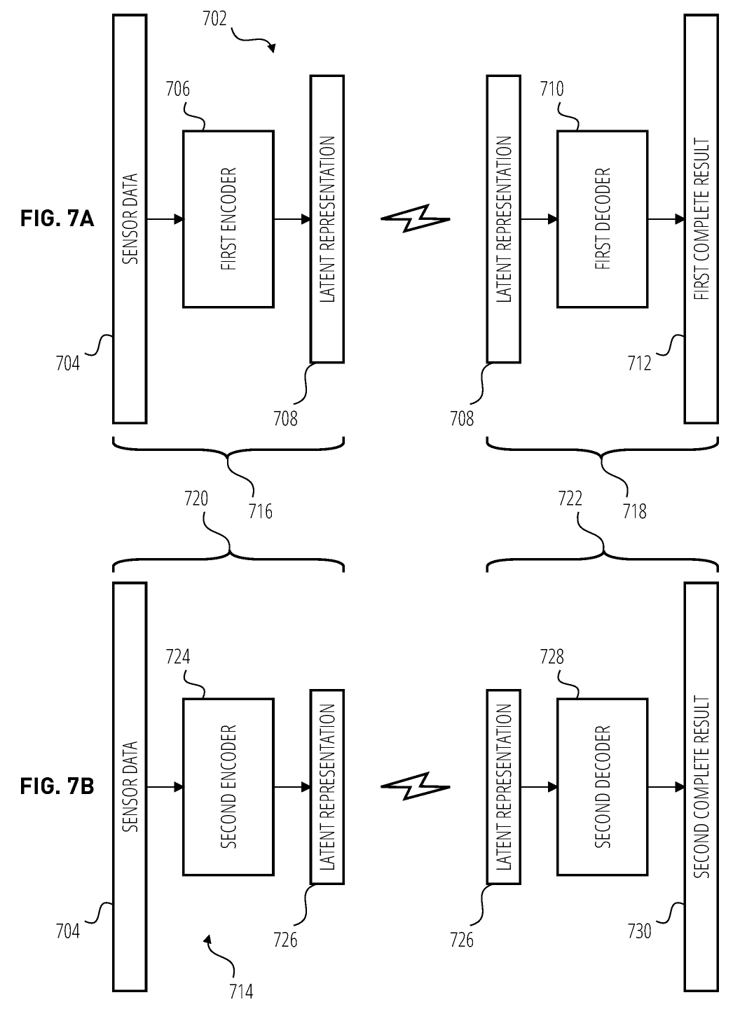

As another non-limiting example embodiment of a suitable machine learning model architecture, the machine learning model architecture may be an encoder-decoder, with the local portion being the encoder, the remote portion being the decoder, and the intermediate result being the latent representation output by the encoder. FIG. 7A and FIG. 7B are schematic illustrations of non-limiting example embodiments of encoder-decoder architectures for use in creating a split machine learning model, according to various aspects of the present disclosure. In FIG. 7A, a third split machine learning model architecture 702 is shown wherein the sensor data 704 is provided to a first encoder 706, which is configured to produce a first latent representation 708 of the sensor data 704 as an intermediate result. The first latent representation 708 is then provided to a first decoder 710, which generates a first complete result 712. The first encoder 706 may be provided to the autonomous vehicle computing system 104 to create the local portion 716, and the remote portion 718 may be provided to the remote computing system 102 to create the remote portion 718. The first encoder 706 and first decoder 710 may themselves use any suitable architecture, including but not limited to stacks of recurrent neural networks, long short-term memory (LSTM) networks, or other architectures.

In FIG. 7B, a fourth split machine learning model architecture 714 is shown. Similar to the third split machine learning model architecture 702, the fourth split machine learning model architecture 714 provides the sensor data 704 to a second encoder 724, which produces a second latent representation 726 as an intermediate result. The second latent representation 726 is then provided to the second decoder 728, which decodes the second latent representation 726 to create a second complete result 730. The second encoder 724 is used as the local portion 720, and the second decoder 728 is used as the remote portion 722. The difference between the fourth split machine learning model architecture 714 and the third split machine learning model architecture 702 is that the second encoder 724 and second decoder 728 are configured to encode and decode a latent representation that is smaller than the latent representation used by the first encoder 706 and first decoder 710. Thus, the fourth split machine learning model architecture 714 may be more suitable for use in situations with a lower amount of available bandwidth than the third split machine learning model architecture 702.

Though FIG. 6B and FIG. 6D show intermediate result types of two different sizes, and FIG. 7A and FIG. 7B show intermediate result types of two different sizes, one will recognize that in some embodiments, more than two different split machine learning models may be generated, and so intermediate result types of more than two different sizes may be available for different amounts of available bandwidth. One will also recognize that while the terms “local” and “remote” are applied to the local portion and remote portion of the split machine learning model, these terms are used for the purpose of disambiguation only, and should not be considered to imply a requirement of a specific type or location of a computing system to be executing the local portion or remote portion.

One will also recognize that, if smaller intermediate results are generated, the quality of the complete result generated by the split machine learning model may be degraded in certain ways. For example, by reducing the size of the latent representation in an encoder-decoder model, the amount of information encoded by the latent representation may be reduced, making it more difficult for the complete result to include high-confidence information. This tradeoff can nevertheless be useful. For example, smaller intermediate results can be transmitted more effectively during periods of a reduced amount of available bandwidth, and a reduced confidence in the complete result may be considered a fair tradeoff for maintaining the timeliness of the processing.

In other embodiments, techniques may be used to reduce the size of the intermediate results without unduly impacting the quality of the complete result. In some embodiments, a split machine learning model may be trained to create complete results for information in more than one category. By reducing the quality of the complete result for a first category of information that is of lesser relevance to a time-sensitive task but not reducing the quality for a second category of information that is of greater relevant to the time-sensitive task, a split machine learning model with a smaller intermediate result can be trained successfully to accomplish the same goal.

As a non-limiting example, some embodiments of a split machine learning model may be used to generate semantic labels of various categories of objects in sensor data that includes an image. A first category of information produced by the split machine learning model may be labels of roads visible in the image, and a second category of information produced by the split machine learning model may be labels of landing pads visible in the image. When training the split machine learning model to use a larger intermediate result, a performance threshold for both the labels of the roads and the labels of the landing pads may be relatively high (e.g., the split machine learning model will be trained until the labels for both categories of information achieve a high level of accuracy, such as 90%).

In contrast, when training the split machine learning model to use a smaller intermediate result, the intermediate result may not encode enough information to successfully achieve a high level of accuracy for both categories of information. Accordingly, a decision may be made regarding which category of information is less important. In the present example, amounts of available bandwidth when in the vicinity of a landing pad are likely to be high, and when amounts of available bandwidth are low (such as when the autonomous vehicle 114 is traversing a route), there are unlikely to be landing pads visible. Therefore, it may be determined that the high level of accuracy for road labels is more important than the high level of accuracy for landing pad labels when amounts of available bandwidth are low. In such a situation, a performance threshold for the accuracy of the labels of the roads may remain relatively high (e.g., 90% accurate), while a performance threshold for the accuracy of the labels of the landing pads may be set lower (e.g., 50% accurate).

In some embodiments, instead of splitting the first category of information and the second category of information based on a type of the information represented, the first category of information and the second category of information may be split based on another characteristic. For example, the first category of information may be information within a first region of an image (e.g., a center portion of the image), and the second category of information may be information within a second region of the image (e.g., a peripheral portion of the image). In this example, training of the split machine learning model may prioritize the accuracy of results for the first region of the image over the accuracy of results for the second region of the image. This may be a useful technique for splitting the first category and second category, as it may be expected that results within the first portion of the image are more relevant to operation of the autonomous vehicle 114 than results within the second portion of the image. Further, this example may easily be adjusted to include more or less of the image within the first region, which may correlate to the ability to train a split machine learning model to use a larger or smaller intermediate result while still producing an acceptable complete result.

The application of semantic labels is a non-limiting example of the complete result that may be generated by the split machine learning model. It may be a particularly useful example, in that if the split machine learning model is trained to extract semantic labels (or other information derived from the sensor data) but not to recreate the original sensor data itself, it may be impractical, if not impossible, to recreate the original sensor data from the intermediate result. In this way, privacy of the original sensor data may be achieved.

In other embodiments, the split machine learning model may be used to encode the sensor data into a compressed format at the autonomous vehicle 114 for transmission as the intermediate result, and to decode the intermediate result to restore the sensor data at the remote computing system 102. Similar techniques for adjusting the size of the intermediate result may be used: to reduce the size of the intermediate result, when training the split machine learning model a lower reconstruction accuracy may be accepted for a first category of information compared to a second category of information. For example, a split machine learning model may be trained to accurately reproduce images of structures visible in the sensor data, but to reproduce images of humans, vehicles, or text less accurately.

These techniques may also be leveraged to enhance privacy. For example, for a first category of information, the split machine learning model may be trained to accurately reproduce the information from the sensor data, while for a second category of information which may be more sensitive than the first category of information, the split machine learning model may be trained not to accurately reproduce the information from the sensor data, with a penalty term being added to the loss function used in training if the second category of information is reproduced accurately. As a non-limiting example, the split machine learning model may be trained to accurately reproduce an image included in the sensor data, but may be penalized for accurately reproducing images of faces or text included in the sensor data. In this way, the privacy of the visible faces or text in the sensor data is preserved, because the intermediate result will not be suitable to reconstruct the faces or text.

Returning to FIG. 5A, at block 504, the model management engine 410 stores the remote portions of the two or more split machine learning models in a model data store 408 of the remote computing system 102. In some embodiments, the remote portions may be stored along with an indication of one or more thresholds for the amounts of available bandwidth associated with the remote portions, identifiers of the associated local portions, or other information usable to match the appropriate remote portion to an intermediate result received from an autonomous vehicle computing system 104.

At block 506, a communication engine 414 of the remote computing system 102 transmits the local portions of the two or more split machine learning models to the autonomous vehicle computing system 104. At block 508, a communication engine 222 of the autonomous vehicle computing system 104 receives the local portions and stores the local portions in a model data store 216 of the autonomous vehicle computing system 104. The communication engine 222 may store the local portions along with indications of one or more thresholds for the amounts of available bandwidth associated with the local portions, identifiers of the local portions, and/or other information for managing use of the local portions.

The method 500 then proceeds through a continuation terminal ("terminal A"). The portions of method 500 prior to terminal A may be considered model training and distribution steps. In some embodiments, one or more split machine learning models may have been trained and distributed prior to execution of the method 500. In such embodiments, the method 500 may skip the model training and distribution steps, and may proceed directly from the start block to terminal A.

From terminal A, the method 500 proceeds to block 510, where one or more sensor devices of the autonomous vehicle computing system 104 generate sensor data. The sensor devices that generate the sensor data may include one or more environment sensor devices 212, one or more vehicle state sensor devices 204, and/or combinations thereof. Accordingly, some non-limiting examples of the generated sensor data include one or more of two-dimensional image data, three-dimensional image data, or time series data (e.g., telemetry data, location data, etc.).

At block 512, a bandwidth detection engine 218 of the autonomous vehicle computing system 104 detects an amount of available bandwidth between the autonomous vehicle computing system 104 and the remote computing system 102. Various techniques for detecting the amount of available bandwidth may be used, including but not limited to detecting an active communication interface 202 (e.g., Wi-Fi vs. LTE vs. 3G, etc.), detecting a wireless signal strength, and/or transmitting a predetermined amount of data between the autonomous vehicle computing system 104 and the remote computing system 102 to measure the round-trip communication time.

The method 500 then proceeds to a continuation terminal ("terminal B"). From terminal B (FIG. 5B), the method 500 proceeds to block 514, where a local model execution engine 220 of the autonomous vehicle computing system 104 retrieves a local portion from the model data store 216 corresponding to the amount of available bandwidth. In some embodiments, the local model execution engine 220 may compare the amount of available bandwidth to one or more threshold values, and may retrieve an appropriate local portion from the model data store 216 based on the comparison.

At block 516, the local model execution engine 220 processes the sensor data using the local portion to generate an intermediate result. For example, if the split machine learning model is an encoder-decoder model, the local portion may process the sensor data to create a latent representation of the sensor data to be used as the intermediate result. As another example, if the split machine learning model is an artificial neural network model, the local portion may process the sensor data to generate a set of activations to be used as the intermediate result. As the different local portions stored in the model data store 216 generate intermediate results of different sizes, the intermediate result will have a size appropriate for transmission to the remote computing system 102 using the detected amount of available bandwidth.

At block 518, the communication engine 222 transmits the intermediate result to the remote computing system 102. At block 520, the model management engine 410 retrieves a remote portion from the model data store 408 corresponding to the intermediate result. In some embodiments, the communication engine 222 may add an indication of the detected amount of available bandwidth, an identifier of the local portion, or other information to the transmission to enable the remote computing system 102 to select the remote portion that corresponds to the local portion used by the local model execution engine 220.

At block 522, the model management engine 410 processes the intermediate result using the remote portion to generate a complete result. For example, if the split machine learning model is an artificial neural network and the intermediate result is a set of activations, the model management engine 410 provides the set of activations to the remote portion to generate the complete result. As another example, if the split machine learning model is an encoder-decoder and the intermediate result is a latent representation, the model management engine 410 provides the latent representation to the remote portion to generate the complete result.

At block 524, the model management engine 410 stores the complete result in a result data store 412 of the remote computing system 102. The complete result may then be used for any suitable purpose. In some embodiments, the complete result may be transmitted back to the autonomous vehicle computing system 104 so that the autonomous vehicle computing system 104 may make a decision about an autonomous operation. For example, if the complete result includes semantic labels of one or more objects visible in an image, then the autonomous vehicle computing system 104 may make autonomous navigation decisions based on the semantic labels. In some embodiments, the complete result may be used by the remote computing system 102 to determine an operational command to be transmitted to the autonomous vehicle computing system 104. For example, the remote computing system 102 may use the complete result to determine that an abort condition exists (e.g., an unnavigable obstacle is present, a state of the autonomous vehicle 114 indicates a likelihood of mission failure, etc.), and may transmit a command to the autonomous vehicle computing system 104 to cause the mission of the autonomous vehicle 114 to be aborted.

The method 500 then proceeds to a decision block 526, where a determination is made regarding whether the method 500 is finished processing sensor data. In some embodiments, the method 500 may continue as long as the autonomous vehicle 114 is performing a mission or traversing a route. In such cases, the method 500 may not be finished unless the autonomous vehicle 114 has landed or otherwise completed its mission. In some embodiments, the method 500 may continue as long as sensor data remains on the autonomous vehicle computing system 104 to be transmitted to the remote computing system 102, whether or not the autonomous vehicle 114 has completed its mission.

If it is determined that the method 500 is not finished processing sensor data, then the result of decision block 526 is NO, and the method 500 returns to terminal A to gather and process further sensor data. Otherwise, if it is determined that the method 500 is finished processing sensor data, then the result of decision block 526 is YES, and the method 500 proceeds to an end block and terminates.

Though communication between a single autonomous vehicle computing system 104 and remote computing system 102 has been illustrated and described for the sake of simplicity, one will recognize that in some embodiments, a plurality of autonomous vehicle computing systems 104 may operate and communicate with the remote computing system 102, either sequentially or at least partially concurrently.

In the preceding description, numerous specific details are set forth to provide a thorough understanding of various embodiments of the present disclosure. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The order in which some or all of the blocks appear in each method flowchart should not be deemed limiting. Rather, one of ordinary skill in the art having the benefit of the present disclosure will understand that actions associated with some of the blocks may be executed in a variety of orders not illustrated, or even in parallel.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A computer-implemented method of communicating sensor data between an autonomous vehicle computing system and a remote computing system, the method comprising:
gathering, by the autonomous vehicle computing system, sensor data generated by at least one sensor of the autonomous vehicle computing system;
determining, by the autonomous vehicle computing system, an amount of available bandwidth between the autonomous vehicle computing system and the remote computing system;
retrieving, by the autonomous vehicle computing system, a local portion of a split machine learning model corresponding to the amount of available bandwidth from a model data store;
processing, by the autonomous vehicle computing system, the sensor data using the local portion to produce an intermediate result; and
transmitting, by the autonomous vehicle computing system, the intermediate result to the remote computing system for processing of the intermediate result using a remote portion of the split machine learning model.

2. The computer-implemented method of claim 1, wherein the model data store has stored therein a first local portion configured to produce a first intermediate result type and a second local portion configured to produce a second intermediate result type;
wherein the first intermediate result type has a first size and the second intermediate result type has a second size smaller than the first size; and
wherein retrieving the local portion of the split machine learning model corresponding to the amount of available bandwidth from the model data store includes:
retrieving the first local portion in response to determining that the amount of available bandwidth is greater than a bandwidth threshold; and
retrieving the second local portion in response to determining that the amount of available bandwidth is not greater than the bandwidth threshold.

3. The computer-implemented method of claim 1, wherein the split machine learning model is an artificial neural network model;
wherein the local portion of the split machine learning model includes an input layer and a first set of hidden layers;
wherein the remote portion of the split machine learning model includes a second set of hidden layers and an output layer; and
wherein the intermediate result is a set of activations between the first set of hidden layers and the second set of hidden layers.

4. The computer-implemented method of claim 1, wherein the split machine learning model is an encoder-decoder model;
wherein the local portion of the split machine learning model includes at least one encoder;
wherein the remote portion of the split machine learning model includes at least one decoder; and
wherein the intermediate result is a latent representation of the sensor data.

5. The computer-implemented method of claim 2, wherein the first intermediate result type is processable by the remote portion of the split machine learning model for a first information category with high confidence and a second information category with high confidence; and
wherein the second intermediate result type is processable by the remote portion of the split machine learning model for the first information category with high confidence for the second information category with low confidence.

6. The computer-implemented method of claim 5, wherein the first information category is a first semantic label type, and wherein the second information category is a second semantic label type.

7. The computer-implemented method of claim 5, wherein the first information category is a first portion of an image, and wherein the second information category is a second portion of the image.

8. The computer-implemented method of claim 1, wherein the intermediate result is processable by the remote portion of the split machine learning model to recreate the sensor data without recreating sensitive information within the sensor data.

9. The computer-implemented method of claim 8, wherein the sensitive information includes at least one of face image information and text information.

10. The computer-implemented method of claim 1, wherein the sensor data includes at least one of a two-dimensional image, a three-dimensional image, and a time series of values.

11. The computer-implemented method of claim 1, wherein the remote computing system is a server computing system or a second autonomous vehicle computing system.

12. A non-transitory computer-readable medium having computer-executable instructions stored thereon that, in response to execution by one or more processors of an autonomous vehicle computing system, cause the autonomous vehicle computing system to perform actions for communicating sensor data between the autonomous vehicle computing system and a remote computing system, the actions comprising:
gathering, by the autonomous vehicle computing system, sensor data generated by at least one sensor of the autonomous vehicle computing system;
determining, by the autonomous vehicle computing system, an amount of available bandwidth between the autonomous vehicle computing system and the remote computing system;
retrieving, by the autonomous vehicle computing system, a local portion of a split machine learning model corresponding to the amount of available bandwidth from a model data store;
processing, by the autonomous vehicle computing system, the sensor data using the local portion to produce an intermediate result; and
transmitting, by the autonomous vehicle computing system, the intermediate result to the remote computing system for processing of the intermediate result using a remote portion of the split machine learning model.

13. The non-transitory computer-readable medium of claim 12, wherein the model data store has stored therein a first local portion configured to produce a first intermediate result type and a second local portion configured to produce a second intermediate result type;
wherein the first intermediate result type has a first size and the second intermediate result type has a second size smaller than the first size; and
wherein retrieving the local portion of the split machine learning model corresponding to the amount of available bandwidth from the model data store includes:
retrieving the first local portion in response to determining that the amount of available bandwidth is greater than a bandwidth threshold; and
retrieving the second local portion in response to determining that the amount of available bandwidth is not greater than the bandwidth threshold.

14. The non-transitory computer-readable medium of claim 12, wherein the split machine learning model is an artificial neural network model;
wherein the local portion of the split machine learning model includes an input layer and a first set of hidden layers;
wherein the remote portion of the split machine learning model includes a second set of hidden layers and an output layer; and
wherein the intermediate result is a set of activations between the first set of hidden layers and the second set of hidden layers.

15. The non-transitory computer-readable medium of claim 12, wherein the split machine learning model is an encoder-decoder model;
wherein the local portion of the split machine learning model includes at least one encoder;
wherein the remote portion of the split machine learning model includes at least one decoder; and
wherein the intermediate result is a latent representation of the sensor data.

16. The non-transitory computer-readable medium of claim 13, wherein the first intermediate result type is processable by the remote portion of the split machine learning model for a first information category with high confidence and a second information category with high confidence; and
wherein the second intermediate result type is processable by the remote portion of the split machine learning model for the first information category with high confidence for the second information category with low confidence.

17. The non-transitory computer-readable medium of claim 16, wherein the first information category is a first semantic label type and the second information category is a second semantic label type; or
the first information category is a first portion of an image and the second information category is a second portion of the image.

18. The non-transitory computer-readable medium of claim 12, wherein the intermediate result is processable by the remote portion of the split machine learning model to recreate the sensor data without recreating sensitive information within the sensor data.

19. The non-transitory computer-readable medium of claim 18, wherein the sensitive information includes at least one of face image information and text information.

20. The non-transitory computer-readable medium of claim 12, wherein the sensor data includes at least one of a two-dimensional image, a three-dimensional image, and a time series of values.
